(19) United States
(12) Patent Application Publication
(10) Pub. No.: US 2024/0232515 A1
(43) Pub. Date: Jul. 11, 2024

(54) PROVIDING TAGGING ASSISTANCE AND COMPLIANCE REVIEW IN CONNECTION WITH STANDARDIZED DOCUMENTS

(71) Applicants: Michael L. Rohan, Greenwood Village, CO (US); Kevin D. Berens, Castle Rock, CO (US)

(72) Inventors: Michael L. Rohan, Greenwood Village, CO (US); Kevin D. Berens, Castle Rock, CO (US)

(73) Assignee: RIVET SOFTWARE, INC. A Delaware Corporation, (omitted)

(21) Appl. No.: 12/730,209

(22) Filed: Mar. 23, 2010

Related U.S. Application Data
(60) Provisional application No. 61/162,446, filed on Mar. 23, 2009.

(51) Int. Cl. G06F 40/174; G06F 40/117

(52) U.S. Cl. CPC G06F 40/174; G06F 40/117

(57) ABSTRACT

Systems and methods for facilitating the review of standardized documents and tagging such documents are provided. According to one embodiment, a method of communicating tag popularity is provided. In the context of a financial document processing application, which is configured to facilitate (i) tagging of financial information with taxonomy clements and (ii) creation of standardized documents in a form suitable for filing with a regulatory agency, tagged financial information is presented. Usage data is received by the financial document processing application relating to aggregate usage of taxonomy elements in standardized documents previously filed with the regulatory agency by filing companies. Visual feedback is then provided with respect to tagging conformance of the tagged financial information based on the usage data by displaying, within a user interface of the financial document processing application, an indication of prevalence of usage of the taxonomy clements among the filing companies.

### CROSS-REFERENCE TO RELATED APPLICATIONS

This application claims the benefit of priority of US Provisional Application No. 61/162,446, filed on Mar. 23, 2009, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2009-2011 Rivet Software, Inc.

### BACKGROUND

### Field

Embodiments of the present invention generally relate to translating or converting business documents, such as financial statements and/or mutual fund prospectuses, into a standardized, tagged format, such as the extensible Business Reporting Language (XBRL), suitable for data processing and, in particular to a standardized document creation tool and reviewing tool that provides one or more of (i) a review process that provides peer group information, and other relevant document information to assist reviewers, (ii) template creation and (iii) tagging assistance features to facilitate preparation of standardized documents.

### Description of Related Art

XBRL provides a standard for allowing business data to be exchanged among different computer systems and software applications. XBRL is based upon the extensible Markup Language (XML) and has been developed by a consortium of companies and organizations worldwide (such as accounting firms, trade organizations, software vendors, financial institutions and governments). XBRL provides a basis for users to “tag” or “mark up” data within business documents with standardized classifications or definitions which span a multitude of industry reporting and accounting standards and allow a variety of software applications to understand the meaning and context of the information. As just one example of the use of XBRL, in 2005, the United States Securities and Exchange Commission (SEC) began a voluntary interactive data filing program. The voluntary interactive data filing program allows public companies to submit SEC reports in XBRL. The SEC has recently issued final rules requiring the use of XBRL for financial reporting for publicly traded companies starting with filing periods on or after Jun. 15, 2009.

As summarized on the XBRL International website:

“The idea behind XBRL is simple. Instead of treating business information as a block of text—as in a standard internet page or a printed document—it provides an identifying tag for each individual item of data. This is computer readable. For example, company net profit has its own unique tag.

The introduction of XBRL tags enables automated processing of business information by computer software, cutting out laborious and costly processes of manual re-entry and comparison. Computers can treat XBRL data ‘intelligently’: they can recognize the information in a XBRL document, select it, analyze it, store it, exchange it with other computers and present it automatically in a variety of ways for users. XBRL greatly increases the speed of handling of financial data, reduces the chance of error and permits automatic checking of information.

Companies can use XBRL to save costs and streamline their processes for collecting and reporting financial information. Consumers of financial data, including investors, analysts, financial institutions and regulators, can receive, find, compare and analyze data much more rapidly and efficiently if it is in XBRL format.

XBRL can handle data in different languages and accounting standards. It can flexibly be adapted to meet different requirements and uses. Data can be transformed into XBRL by suitable mapping tools or it can be generated in XBRL by appropriate software.”

While the foregoing quote from the XBRL web site notes a number of benefits associated with the association of XBRL attributes with data in a business document (which is also known as “tagging”), the accountants and other individuals that generate the business documents for which XBRL tagging is appropriate typically have to associate tagging information with data in their business documents via text/XML editing tools, such as “Microsoft Notepad,” or by using complex XBRL-based stand-alone applications that require user to copy/paste, re-key or import data before being able to convert to XBRL.

Consequently, there is a need for improved tools that allow individuals to efficiently create and review such documents containing interactive data.

### SUMMARY

Systems and methods are described for simplifying the creation of standardized documents, facilitating the review of such documents and tagging such documents. According to one embodiment, a method of communicating tag popularity is provided. Tagged financial information of a company is presented by a financial document processing application running on a computer system to an end user for review or additional tagging. The financial document processing application is configured to facilitate (i) tagging of financial information with taxonomy elements and (ii) creation of standardized documents in a form suitable for filing with a regulatory agency. Usage data for filing companies is received by the financial document processing application relating to aggregate usage of taxonomy elements in connection with standardized documents previously filed with the regulatory agency by the filing companies. The taxonomy elements for which usage data is received are among a current set of taxonomy elements used within the tagged financial information Visual feedback is provided to the end user with respect to tagging conformance of the tagged financial information based on the usage data by displaying, within a user interface of the financial document processing application, an indication of prevalence of usage of the taxonomy elements among the filing companies.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a flow diagram illustrating data center processing in accordance with an embodiment of the present invention.

FIG. 2 is a flow diagram illustrating tag popularity communication processing in accordance with an embodiment of the present invention.

FIGS. 3A-D are screen shots from a financial document processing application illustrating standardized document tagging assistance functionality in accordance with an embodiment of the present invention.

FIG. 4 is an annotated screen shot from a financial document processing application illustrating standardized document compliance review functionality in accordance with an embodiment of the present invention.

FIG. 5 is a screen shot from a financial document processing application illustrating standardized document compliance review functionality in accordance with an embodiment of the present invention.

FIG. 6 is an example of a computer system with which embodiments of the present invention may be utilized.

### DETAILED DESCRIPTION

Systems and methods are described for simplifying the creation of standardized documents, facilitating the review of such documents and tagging such documents. Many business documents must be converted to a standardized format such as XML (Extensible Markup Language) and XBRL (Extensible Business Reporting Language), or similar standards. XBRL and several other standards are based on XML, but add specific elements and structure to accommodate a specific need. XBRL, for example is focused on financial and business reporting. In various embodiments of the present invention, a new product approach is provided that greatly simplifies the process of building a standardized document (including, but not limited to XBRL instance documents). In one embodiment, a single unified approach is provided to facilitate creation of and interaction with standardized documents. Embodiments recognize that a collection of data (including, but not limited to a financial report) can be the focal point of many different types of taxonomies (or other groupings of metadata). In one embodiment, these different taxonomies can be defined as an “input taxonomy” to define the import of data into a report (or data collection) and a “output taxonomy” used to “tag” or identify report elements for use in an exported document, including, but not limited to an XBRL instance document.

In various embodiments of the present invention, a review process is enabled that provides peer group information, and other relevant document information to assist reviewers (including, but not limited to External Auditors) determine the appropriateness of tagging and other presentation information. For example, when reviewing an XBRL document, a reviewer may be alerted when an XBRL taxonomy element was significantly different than the clement selected by other document preparers in the same industry.

According to one embodiment of the present invention, a review process is enabled that provides peer group information, and other relevant document information to assist reviewers (including, but not limited to External Auditors) determine the appropriateness of tagging and other presentation information. For example, when reviewing an XBRL document, a reviewer may be alerted when an XBRL taxonomy clement was significantly different than the element selected by other document preparers in the same industry.

According to another embodiment of the present invention, several “Tagging Assistance” capabilities are provided that assist users with the selection of appropriate base or extended taxonomy elements to identify financial or accounting concepts contained in a financial statement or similar document. For example, US Public Companies may use the Tagging Assistance capabilities to facilitate their preparation of XBRL documents for submission to the SEC. Depending upon the particular implementation, the tagging assistance features may include one or more of the following (i) a mechanism for users to specify either an industry group or a manual or automated selection of other public companies (by one or more selection criteria, including, but not limited to size, revenues, region, business activities undertaken, liabilities of the members and directors, membership pattern/size, place of registration, control over the management, etc.) to be used as informational sources to assist in the selection of taxonomy elements or other presentation concepts; and (ii) search capabilities that utilize descriptive information in a report to search taxonomy for relevant elements to be considered for tagging.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Embodiments of the present invention may be provided as a computer program product which may include a machine-readable medium having stored thercon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

While, for convenience, various embodiments of the present invention may be described with reference to the XBRL standard, the concepts discussed herein are designed for use with XML (or similar tagging systems) and all related standards focused on business, finance, or accounting. As such, references to standardized documents or XBRL instance documents should be understood to include XML, XBRL, and related systems.

For the sake of illustration, various embodiments of the present invention are described herein in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be couple directly, or via one or more intermediary media or devices. As another example, devices may be coupled in such a way that information can be passed there between, while not sharing any physical connection on with another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

According to one embodiment of the present invention, an audit and compliance review process allows anyone to review a tagged document (such as an XBRL Instance Document) and quickly determine how the document compares to either a collection of other documents (say, XBRL documents prepared by other companies in the same industry or portfolio), or any predetermined or aggregated data table. In one embodiment, the review process provides a visual display highlighting areas of interest, and statistics regarding the document, such as percentage of elements outside certain standard deviations from industry norms, and/or number of elements added to an extension taxonomy.

The review process can be incorporated into a document preparation workflow, or may be done after the fact from a final XBRL Instance Document. Some of the specific review features include one or more of: (i) display of tagged elements highlighting differences in tagging between the object report and other reports from other companies in the same industry or from aggregate statistics prepared by the reviewer; (ii) allowing a reviewer to extend the functionality of the review software by adding their own business rules and other review criteria to create a highly customized review and control process; and (iii) adding a customized review process to a workflow so specific persons or groups are notified when specific characteristics are identified.

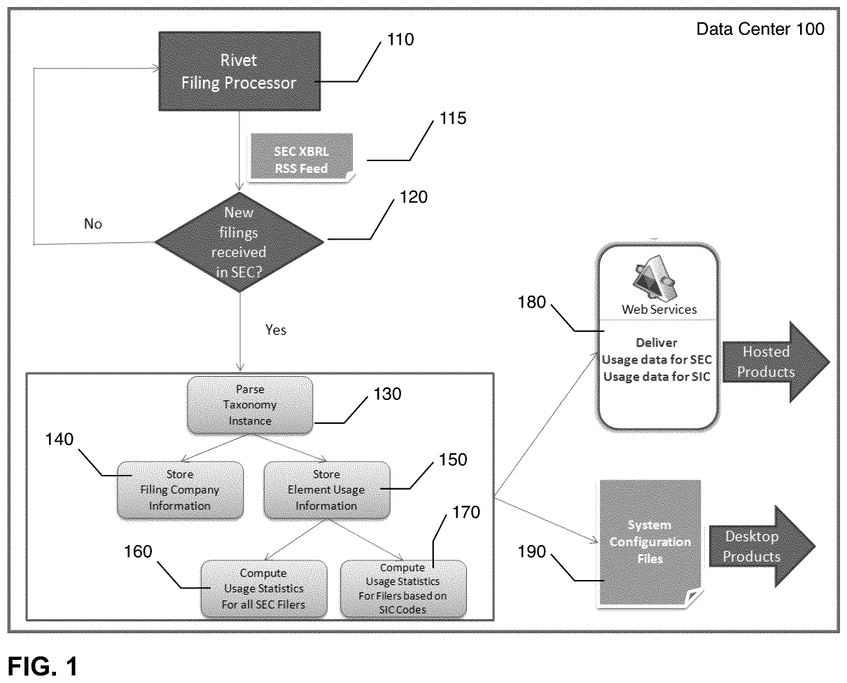

In one embodiment, in order to support the tagging assistance and audit and compliance review functionality, the data center processing described with respect to FIG. 1 may be used to gather the benchmark information for US SEC filings. The same methodology is equally applicable to benchmarking capabilities in connection with other markets.

FIG. 1 is a flow diagram illustrating data center processing in accordance with an embodiment of the present invention. In the present example, a scheduling-enabled service, Rivet filing processor 110, running in a data center 100 monitors a feed associated with a regulatory body, e.g., SEC RSS feed 115, to check if new filings are available for processing. At decision block 120, if no new filings are available, control loops back to block 110; otherwise, if new filings are available, processing continues with block 130.

At block 130, new taxonomy instances representing standardized documents, e.g., XBRL instance documents, filed by filing companies are parsed to identify filing company information and element usage information. At blocks 140 and 150 the filing company information and element usage information are stored in a database.

At block 160, usage statistics for all filers (e.g., all SEC filers) are computed. At block 170, filing companies are categorized based on SEC specified SIC codes or the like and usage statistics for filers are calculated by SIC code or the like.

In one embodiment, for purposes of calculating usage statistics, each filing company has a base point of 1. When a given element is used for a company (no matter how many times the element was used), that element is given a score of 1.

As a non-limiting example of calculating tag popularity, if there are 100 companies and 50 of them used the “sales revenue” reporting element in standardized documents filed with the regulatory agency in question, then the calculated SEC percentage for the “sales revenue” reporting element would be 50%.

As an additional non-limiting example of calculating tag popularity, if for a given industry group (e.g., SIC code) there are 10 companies and 3 of them used the reporting element “sales revenue” in standardized documents filed with the regulatory agency in question, then the SIC percentage for the “sales revenue” reporting element for this industry group would be 30%.

At block 180, usage data, e.g., SEC and SIC percentages are delivered via web services (live updates) for hosted products, for example.

At block 190, the usage data may be delivered through one or more encrypted configuration files that can be downloaded from a corporate website or through an automatic refresh method implemented in the desktop products, for example.

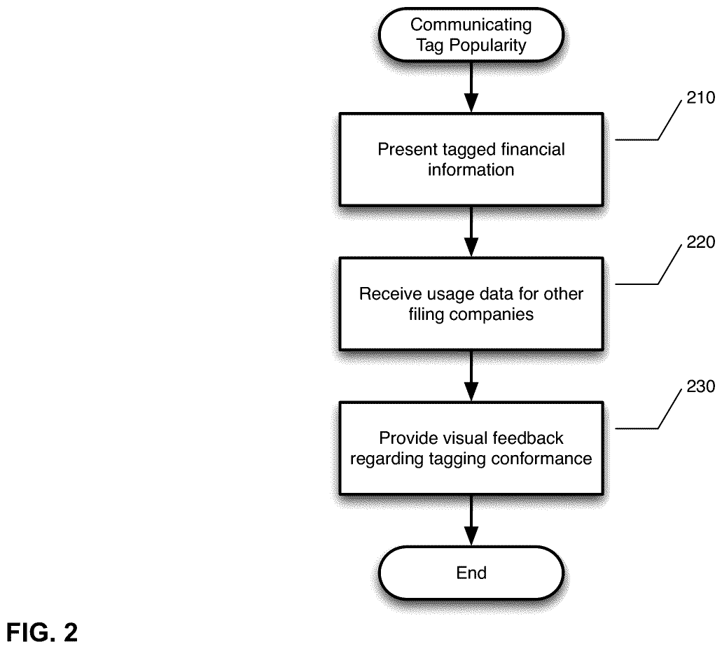

FIG. 2 is a flow diagram illustrating tag popularity communication processing in accordance with an embodiment of the present invention. At block 210, tagged financial information is presented to an end user via a financial document processing application (e.g., an XBRL tagging application) running on a computer system (e.g., a desktop computer or a server of an application service provider). The end user may be an external auditor of the company, an internal or external reviewer, a compliance officer of the company, a regulator employed by the regulatory agency or an investor.

At block 220, usage data for other filing companies is received. For example, usage statistics for reporting elements present within tagged financial information may be retrieved via web services (live update) from a data center that calculates and maintains such information. In one embodiment, usage statistics may be separately calculated for all filing companies as a whole and for discrete groups based on SIC code or the like (e.g., a North American Industry Classification System (NAICS) code, an International Standard Industrial Classification system code, a Global Industry Classification Standard code, a United Kingdom Standard Industrial Classification of Economic Activities code, an Industry Classification Benchmark (ICB) code, a Russian Economic Activities Classification System (OKVED) code or a Statistical classification of economic activities in the European Community (NACE) code). Alternatively, such usage statistics may be calculated on the basis of one or more of various characteristics (e.g., number of employees, annual revenues, geographic region of business activities undertaken, types of the business activities undertaken, liabilities of members and directors, place of registration and control over management) that may be used to define peer groups within the filing companies.

At block 230, visual feedback is provided to the end user of the financial document processing application regarding tagging conformance of the tagged financial information with industry norms based on the usage data. For example, an indication of prevalence of usage of one or more base or extended taxonomy elements (e.g., XBRL reporting elements) among all filing companies and/or a subset of filing companies (e.g., a peer group or industry group) may be conveyed to the end user via a graphical user interface of the financial document processing application as described in further detail below. In one embodiment, cells within a report corresponding to usage statistics may be color-coded to provide a visual indicator to the end user. For example, prevalence statistics above a certain pre-defined or user-defined threshold (e.g., 75%) may be colored green (or other user-specified color) and prevalence statistics below a certain pre-defined or user-defined threshold (e.g., 25%) may be colored red. In this manner, an auditor or reviewer can use SEC % and/or SIC % to gauge if the reporting elements currently in use within the tagged financial information at issue are in line with other filing companies.

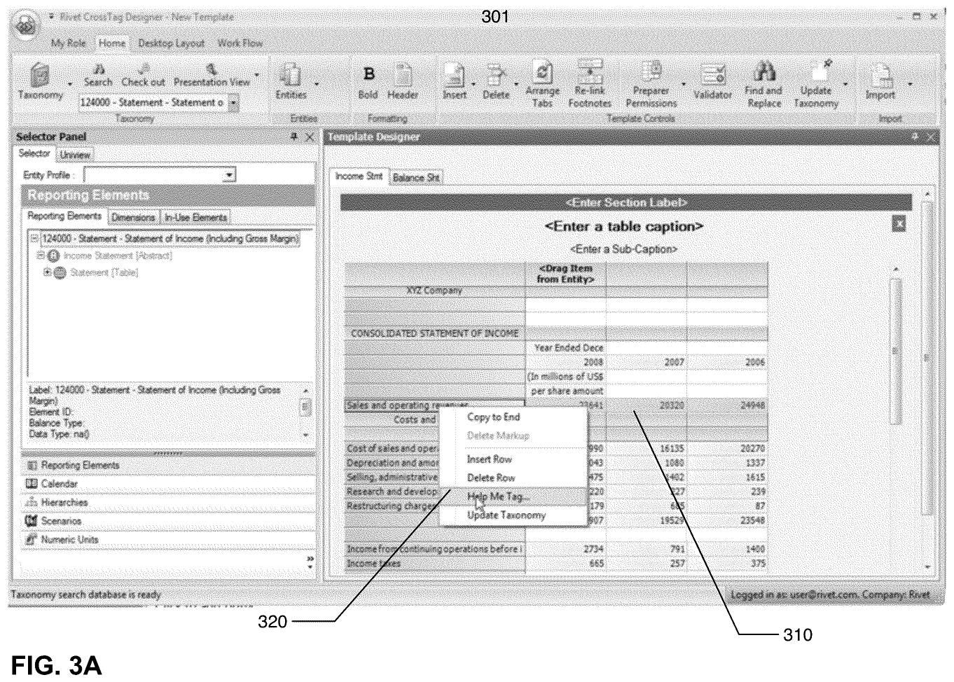

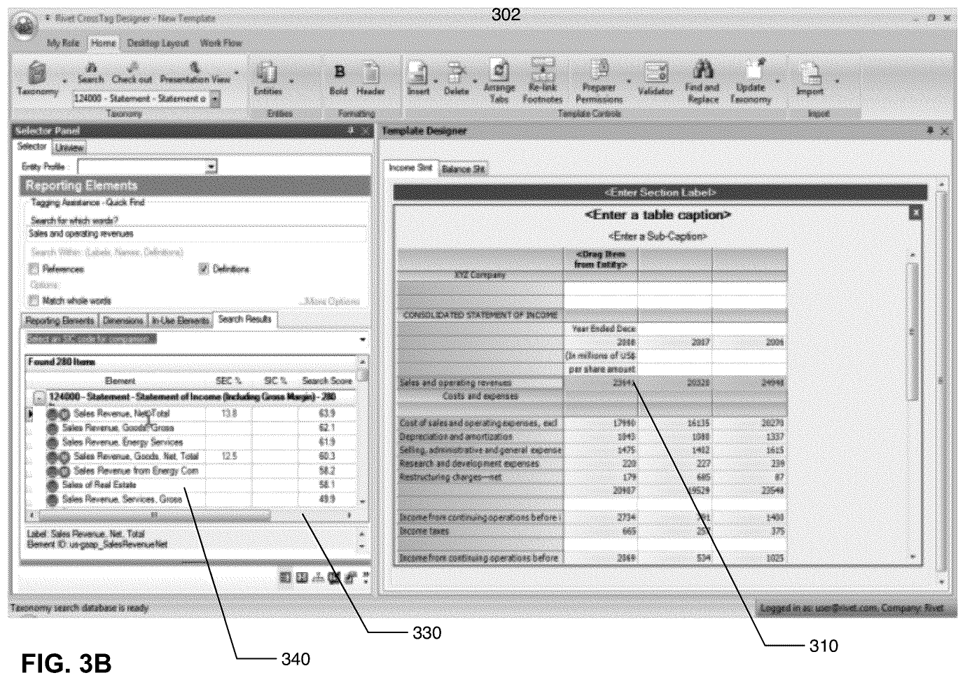

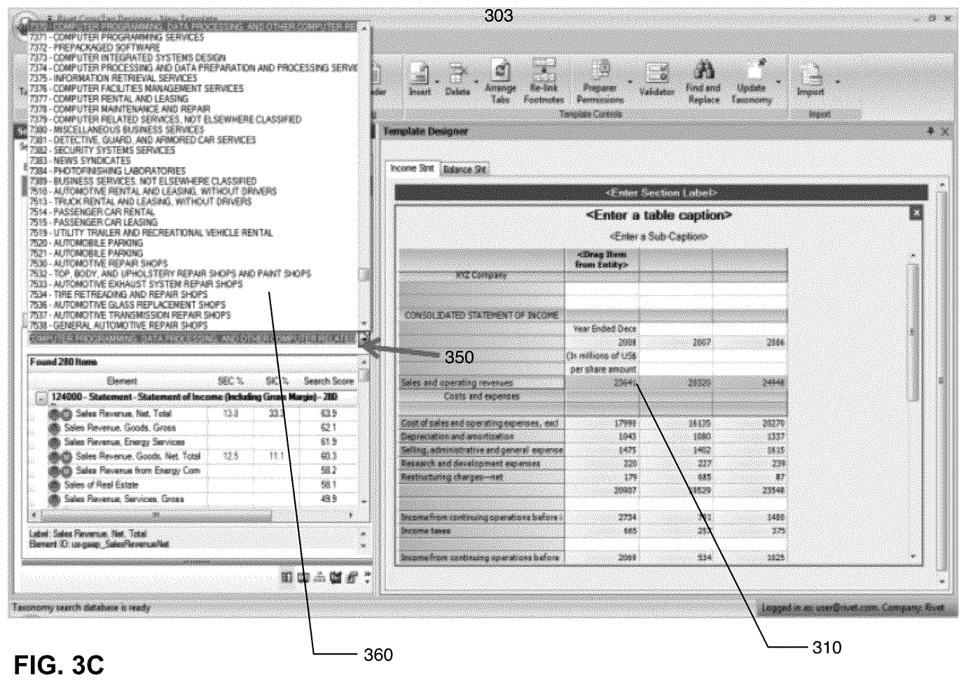

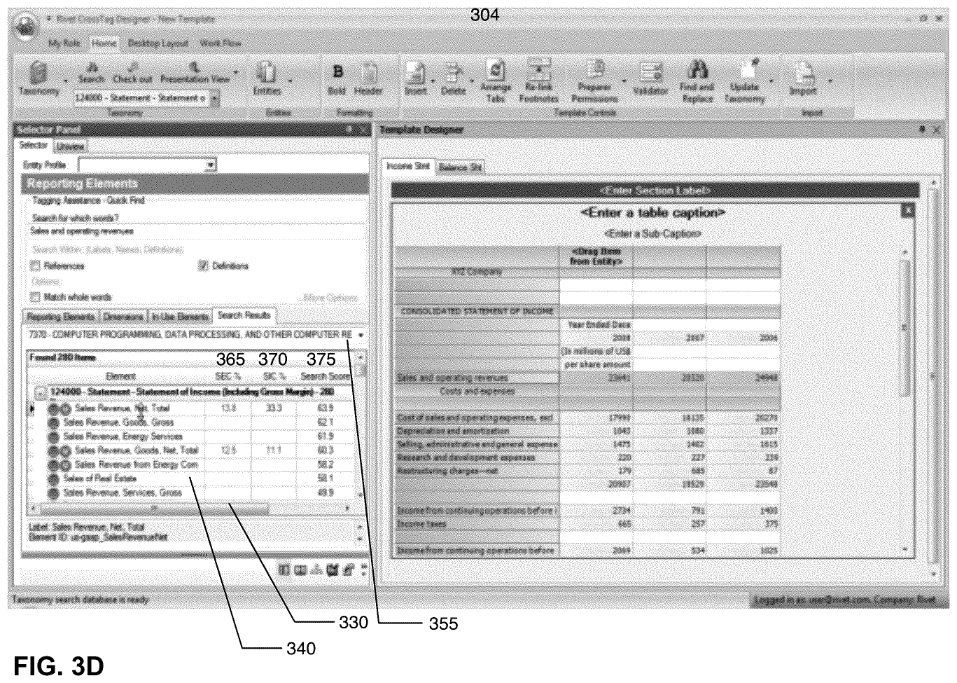

FIGS. 3A-D are screen shots from a financial document processing application illustrating standardized document tagging assistance functionality in accordance with an embodiment of the present invention. Organizations filing reports with regulatory agencies, such as the SEC, benefit from knowing how close to the norm their submission is. In accordance with embodiments of the present invention, the norm is determined by comparing the filing organization at issue to other available filings in aggregate or filtered by specific criteria such as SIC code, size, etc.

In addition to the norm, organizations can benefit from knowing where and if other filing companies have used base elements or extensions versus how many organizations extended the taxonomy and which base clements had the most extensions.

According to one embodiment, as users tag their XBRL data or as a reviewer reviews the XBRL reports and data, they are provided via a graphical user interface with insights into exactly how other companies tagged their data by one or more tagging assistance features. This feature provides end users with information that has never previously been accessible.

In one embodiment, users at a high level will be able to see what percentages of other companies (who have filed using XBRL) have tagged their data. According to one embodiment, aggregate usage data is immediately accessed via a web service, thus providing near-real-time access and ensuring the end user always has the latest filing data. As described further below, end users are provided with the ability to select different options to specifically identify comparison companies (such as companies who are most like themselves). This includes, for example, the ability to select on the basis of similar SIC codes or selecting individual companies for comparison. End users may also be able to enter their label data and extract a list of companies who have used that tag and display what labels they used.

Dependent upon the particular embodiment, this public data is available in a variety of formats including, but not limited to (i) percentage of filers using a particular reporting element or elements; (ii) percentage of filers, filtered by SIC code or something similar that have used a particular reporting element or elements as part of their previous regulatory filings; (iii) percentage of filers, filtered by user selected peer groups or something similar that have used a particular reporting element or elements; (iv) drilldown on the percentage information to determine exactly which companies used a particular reporting element; (v) search mechanisms to help the reviewer or auditor determine alternative reporting elements for those currently being employed; and (vi) drilldown on a particular reporting element to determine what label other filing companies used for the reporting element.

While these screen shots provide exemplary usage scenarios for a standardized document preparer, it is to be noted that the end user of the financial document processing application may operate in one or more other roles. For example, the end user may be an external auditor of the company, an internal or external reviewer, a compliance officer of the company, a regulator employed by the regulatory agency or an investor.

FIG. 3A is a screen shot 301 illustrating a “help me tag” feature, which may be used by a preparer to obtain recommendations regarding alternative reporting elements to a reporting element at issue. In the context of screen shot 301, the preparer is creating an income statement and would like to identify alternative reporting elements to a “Sales and operating revenue” reporting element 310. As such, the preparer has selected a row associated with the “Sales and operating revenue” reporting element 310 and has requested tagging assistance with respect to this element by right-clicking and selecting a “Help Me Tag” item 320 from a pop-up menu, for example.

FIG. 3B is a screen shot 302 illustrating search results 330 resulting from a tagging assistance request. In screen shot 302, search results 330 may provide a list of alternative reporting elements 340 to the reporting element associated with the currently selected row or column 310.

FIG. 3C is a screen shot 303, illustrating available SIC codes 360. In one embodiment, the preparer may select a SIC code to be used for comparison by selecting drop down list button 350. Responsive thereto, a list of available SIC codes 360 may be displayed from which the preparer may select a SIC code corresponding to previously submitted standardized documents of filing companies to which the preparer would like to compare the tagged financial information at issue (e.g., the reporting element associated with the currently selected row or column 310).

FIG. 3D is a screen shot 304, illustrating search results 330 for the selected SIC code 355. In screen shot 304, search results 330 include a list of alternative reporting elements 340 and corresponding prevalence indications for (i) all SEC filing companies as a whole (i.c., column 365 “SEC %”) and (ii) all filing companies within the industry group associated with the selected SIC code 355 (i.c., column 370 “SIC %”) and a search score (i.c., column 375 “Search Score”). In one embodiment, the preparer may sort the alternative reporting elements in ascending or descending order in accordance with the SEC % values 365, the SIC % values or the search score values 375. In this manner, the preparer can determine the appropriateness of using a particular alternative reporting element based on usage statistics by SEC filing companies as a whole for the particular alternative reporting clement and/or based on usage statistics by filing companies within the selected SIC code 355 for the particular alternative reporting element.

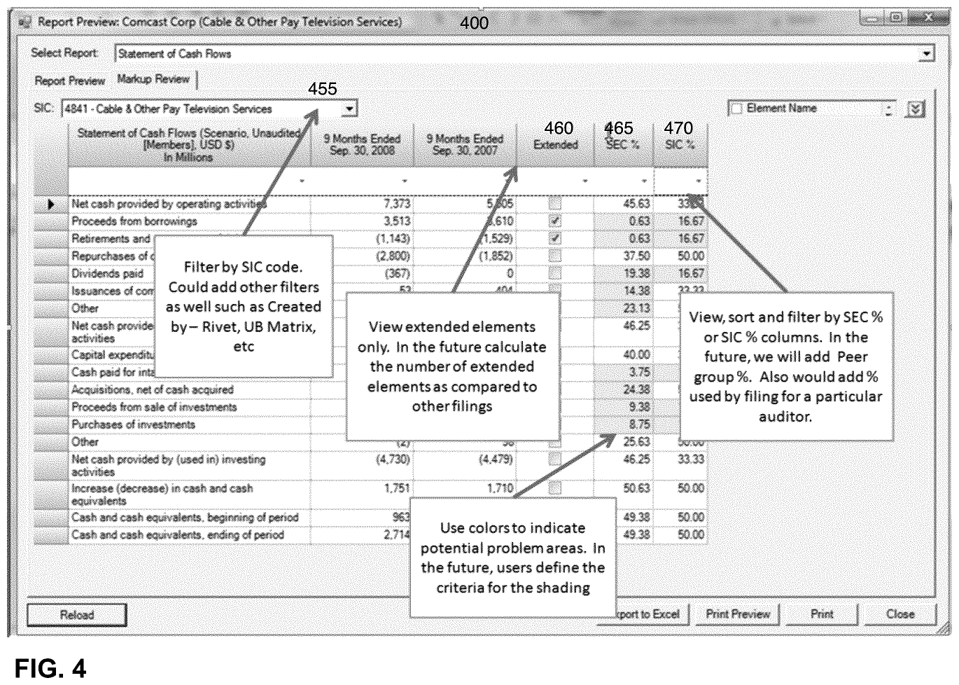

FIG. 4 is an annotated screen shot 400 from a financial document processing application illustrating standardized document compliance review functionality in accordance with an embodiment of the present invention. In screen shot 400, a statement of cash flows report is being displayed by the financial document processing application. In one embodiment, a reviewer (e.g., a compliance officer of the company, a regulator employed by the regulatory agency or an investor) may compare the use of tagging in a given financial report to that of other filing companies. For example, the reviewer may filter by SIC code by entering a SIC code into or selecting a SIC code from a drop down list 455. The reviewer may also select to view only extended or non-extended reporting elements or both. In one embodiment, a checked box in column 460 indicates the corresponding usage data relates to extended reporting elements.

The reviewer may also be provided with visual feedback, such as color-coding to indicate potential tagging conformance/non-conformance with respect to SEC filing companies as a whole (e.g., column 465) and/or filing companies associated with the currently selected SIC code (column 470). In other embodiments, a peer group can be defined based on one or more factors, including, but not limited to number of employees, annual revenues, geographic region of business activities undertaken, types of the business activities undertaken, liabilities of members and directors, place of registration and control over management. In such an embodiment, after a peer group has been defined, an additional column may be displayed showing reporting element prevalence among the defined peer group. It is also contemplated that prevalence of usage for reporting elements at issue may be displayed for a particular auditor or auditing firm, for example.

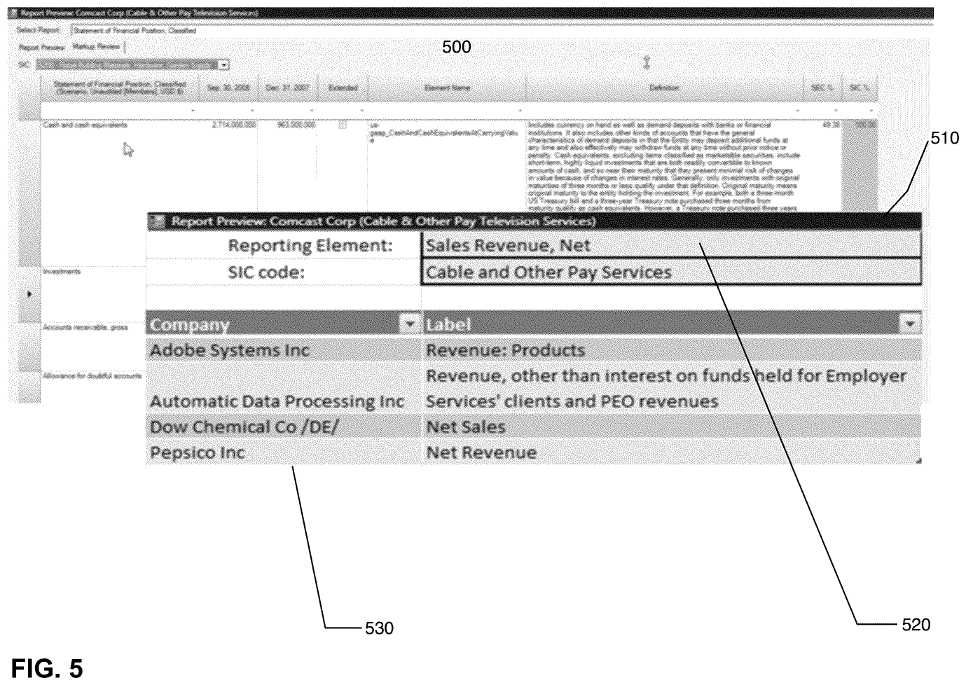

FIG. 5 is a screen shot 500 from a financial document processing application illustrating standardized document compliance review functionality in accordance with an embodiment of the present invention. In screen shot 500, an end user has drilled down on the percentage information (prevalence indication—e.g., SEC %, SIC % or Peer Group %) displayed for a particular reporting element 520 to determine exactly which companies used the particular reporting clement 520. In response, a pop up window 510 is displayed listing the filing companies 530 represented by the prevalence information. Alternatively or additionally, companies that have not used the particular reporting element 520 may be listed and identified as such.

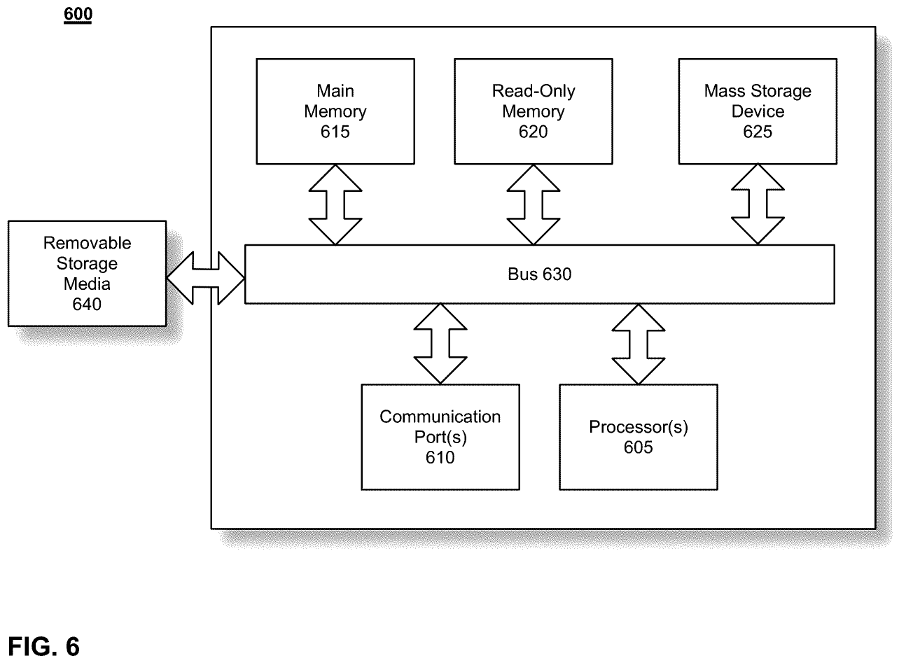

FIG. 6 is an example of a computer system with which embodiments of the present invention may be utilized. Embodiments of the present invention include various steps, which have been described in detail above. A variety of these steps may be performed by hardware components or may be tangibly embodied on a non-transitory computer-readable medium in the form of machine-executable instructions, which may be used to cause a general-purpose or special-purpose processor programmed with instructions to perform these steps. Alternatively, the steps may be performed by a combination of hardware, software, and/or firmware. In the current example, a computer system 600, such as a workstation, personal computer, laptop, a client or server, represents a computing environment upon which or with which embodiments of the present invention may be employed. In some embodiments, a hosted product made available by an application service provider, for example, may provide one or more features described above. In other embodiments, some of the features may be included in a desktop product, run on a local machine or from an enterprise server, for example.

According to the present example, the computer system includes a bus 630, one or more processors 605, one or more communication ports 610, a main memory 615, a removable storage media 640, a read only memory 620 and a mass storage 625.

Processor(s) 605 can be any future or existing processor, including, but not limited to, an Intel® Itanium® or Itanium 2 processor(s), or AMD® Opteron® or Athlon MP® processor(s), or Motorola® lines of processors. Communication port(s) 610 can be any of an RS-232 port for use with a modem based dialup connection, a 10/100 Ethernet port, a Gigabit port using copper or fiber or other existing or future ports. Communication port(s) 610 may be chosen depending on a network, such a Local Area Network (LAN), Wide Area Network (WAN), or any network to which the computer system 600 connects.

Main memory 615 can be Random Access Memory (RAM), or any other dynamic storage device(s) commonly known in the art. Read only memory 620 can be any static storage device(s) such as Programmable Read Only Memory (PROM) chips for storing static information such as start-up or BIOS instructions for processor 605.

Mass storage 625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K 1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 630 communicatively couples processor(s) 605 with the other memory, storage and communication blocks. Bus 630 can include a bus, such as a Peripheral Component Interconnect (PCI) / PCI Extended (PCI-X), Small Computer System Interface (SCSI), USB or the like, for connecting expansion cards, drives and other subsystems as well as other buses, such a front side bus (FSB), which connects the processor(s) 605 to system memory.

Optionally, operator and administrative interfaces, such as a display, keyboard, and a cursor control device, may also be coupled to bus 630 to support direct operator interaction with computer system 600. Other operator and administrative interfaces can be provided through network connections connected through communication ports 610.

Removable storage media 640 can be any kind of external hard-drives, floppy drives, IOMEGA® Zip Drives, Compact Disc—Read Only Memory (CD-ROM), Compact Disc - Re-Writable (CD-RW), Digital Video Disk—Read Only Memory (DVD-ROM).

Components described above are meant only to exemplify various possibilities. In no way should the aforementioned exemplary computer system limit the scope of the invention.

1-2. (canceled)

3. A computer-implemented method comprising:
presenting, by a financial document processing application running on a computer system and configured to facilitate (i) tagging of financial information with taxonomy elements and (ii) creation of standardized documents in a form suitable for filing with a regulatory agency, tagged financial information of a company to an end user for review or additional tagging;
receiving, by the financial document processing application, usage data for one or more filing companies relating to their aggregate usage of one or more taxonomy elements in connection with one or more standardized documents previously filed with the regulatory agency by the one or more filing companies, wherein the one or more taxonomy elements are among a current set of taxonomy elements used within the tagged financial information; and
providing visual feedback to the end user with respect to tagging conformance of the tagged financial information based on the usage data by displaying, within a user interface of the financial document processing application, an indication of prevalence of usage of the one or more taxonomy elements among the one or more filing companies.

4. The method of claim 3, wherein the taxonomy elements comprise extensible Business Rules Language (XBRL) reporting elements and wherein the one or more standardized documents comprise XBRL documents.

5. The method of claim 4, wherein the one or more filing companies comprise all filing companies that file financial reports with the regulatory agency.

6. The method of claim 4, wherein the one or more filing companies represent a subset of all filing companies that file financial reports with the regulatory and which represent a peer group of the company in terms of one or more characteristics.

7. The method of claim 6, further comprising receiving from the end user information indicative of the one or more characteristics, wherein the one or more characteristics include one or more of an industry group, number of employees, annual revenues, geographic region of business activities undertaken, types of the business activities undertaken, liabilities of members and directors, place of registration and control over management.

8. The method of claim 4, further comprising maintaining, at a data center, a database of usage statistics, from which the usage data is extracted, that are generated based on analysis of historical XBRL document filings submitted to the regulatory agency by filing companies.

9. The method of claim 8, wherein said maintaining comprises:
monitoring, by a filing processor running within the data center, a Really Simple Syndication, RDF Site Summary or Rich Site Summary (RSS) feed to obtain newly submitted filings by any of the filing companies;
parsing XBRL documents representing the newly submitted filings;
based on results of the parsing, storing information regarding the filing companies associated with the newly submitted filings and XBRL reporting element usage information;
based on the XBRL reporting element usage information, updating the usages statistics, including usage statistics for all the filing companies as a whole and usage statistics for one or more predefined subsets of the filing companies.

10. The method of claim 9, wherein the one or more predefined subsets of the filing companies are defined based on one or more of an industry group, number of employees, annual revenues, geographic region of business activities undertaken, types of the business activities undertaken, liabilities of members and directors, place of registration and control over management.

11. The method of claim 10, wherein the industry group is classified consistent with one or more of a Standard Industrial Classification (SIC) system, a North American Industry Classification System (NAICS), an International Standard Industrial Classification system, a Global Industry Classification Standard, a United Kingdom Standard Industrial Classification of Economic Activities, an Industry Classification Benchmark (ICB), a Russian Economic Activities Classification System (OKVED) and a Statistical classification of economic activities in the European Community (NACE).

12. The method of claim 4, wherein the financial document processing application comprises a hosted application and wherein said receiving comprises receiving live updates via web services.

13. The method of claim 4, wherein the financial document processing application comprises a desktop application and wherein said receiving comprises receiving configuration files containing therein the usage data.

14. The method of claim 4, wherein the regulatory agency is the Security Exchange Commission (SEC) and wherein the usage data comprises usage statistics for all SEC filing companies as a whole in relation to each XBRL reporting element of the current set of XBRL reporting elements.

15. The method of claim 4, wherein the end user comprises an external auditor of the company, a compliance officer of the company, a regulator employed by the regulatory agency or an investor.

16. The method of claim 4, wherein the providing visual feedback to the end user comprises highlighting differences in tagging between the tagged financial information and the one or more standardized documents previously filed with the regulatory agency by the one or more filing companies.

17. The method of claim 4, wherein the indication of prevalence comprises color-coding.

18. The method of claim 4, wherein the indication of prevalence comprises numerical data.

19. The method of claim 18, wherein the numerical data represents a percentage of the one or more filing companies that used each of the one or more taxonomy elements in connection with their standardized document filings with the regulatory agency.

20. A computer-implemented method comprising:
presenting, by a financial document processing application running on a computer system and configured to facilitate (i) tagging of financial information with extensible Business Reporting Language (XBRL) reporting elements and (ii) creation of XBRL documents in a form suitable for filing with the United States Securities and Exchange Commission (SEC), tagged financial information of an SEC filing company at issue to an end user for review or additional tagging;
receiving, by the financial document processing application, usage data for a plurality of SEC filing companies within a peer group of the SEC filing company at issue relating to their aggregate usage of one or more XBRL reporting elements in connection with one or more XBRL documents previously filed with the SEC by the plurality of SEC filing companies, wherein the one or more XBRL reporting elements are among a current set of XBRL reporting elements used within the tagged financial information and wherein the peer group is defined by an industry group with which the SEC filing company at issue is associated; and
providing visual feedback to the end user with respect to peer group norms by displaying, within a user interface of the financial document processing application, an indication of a percentage of the plurality of SEC filing companies that have used each of the one or more XBRL reporting elements in connection with their respective SEC filings.

21. The method of claim 20, wherein the industry group comprises a Standard Industrial Classification (SIC) code or a North American Industry Classification System (NAICS) code.

22. The method of claim 21, further comprising maintaining, at a data center, a database of usage statistics, from which the usage data is extracted, that are generated based on analysis of historical XBRL document filings submitted to the SEC by SEC filing companies.

23. The method of claim 20, wherein the providing visual feedback to the end user comprises highlighting differences in tagging between the tagged financial information and the one or more XBRL documents previously filed with the SEC by the plurality of SEC filing companies.

28. A non-transitory program storage device readable by a computer system, tangibly embodying a program of instructions executable by one or more processors of the computer system to perform a method of communicating tag popularity, the method comprising:
presenting, by a financial document processing configured to facilitate (i) tagging of financial information with taxonomy elements and (ii) creation of standardized documents in a form suitable for filing with a regulatory agency, tagged financial information of a company to an end user for review or additional tagging;
receiving, by the financial document processing application, usage data for one or more filing companies relating to their aggregate usage of one or more taxonomy elements in connection with one or more standardized documents previously filed with the regulatory agency by the one or more filing companies, wherein the one or more taxonomy elements are among a current set of taxonomy elements used within the tagged financial information; and
providing visual feedback to the end user with respect to tagging conformance of the tagged financial information based on the usage data by displaying, within a user interface of the financial document processing application, an indication of prevalence of usage of the one or more taxonomy elements among the one or more filing companies.

29. The non-transitory program storage device of claim 28, wherein the taxonomy elements comprise extensible Business Rules Language (XBRL) reporting elements and wherein the one or more standardized documents comprise XBRL documents.

30. The non-transitory program storage device of claim 29, wherein the one or more filing companies comprise all filing companies that file financial reports with the regulatory agency.

31. The non-transitory program storage device of claim 29, wherein the one or more filing companies represent a subset of all filing companies that file financial reports with the regulatory and which represent a peer group of the company in terms of one or more characteristics.

32. The non-transitory program storage device of claim 31, wherein the method further comprises receiving from the end user information indicative of the one or more characteristics, wherein the one or more characteristics include one or more of an industry group, number of employees, annual revenues, geographic region of business activities undertaken, types of the business activities undertaken, liabilities of members and directors, place of registration and control over management.

33. The non-transitory program storage device of claim 29, wherein the method further comprises maintaining, at a data center, a database of usage statistics, from which the usage data is extracted, that are generated based on analysis of historical XBRL document filings submitted to the regulatory agency by filing companies.

34. The non-transitory program storage device of claim 33, wherein said maintaining comprises:
monitoring, by a filing processor running within the data center, a Really Simple Syndication, RDF Site Summary or Rich Site Summary (RSS) feed to obtain newly submitted filings by any of the filing companies;
parsing XBRL documents representing the newly submitted filings;
based on results of the parsing, storing information regarding the filing companies associated with the newly submitted filings and XBRL reporting element usage information;
based on the XBRL reporting element usage information, updating the usages statistics, including usage statistics for all the filing companies as a whole and usage statistics for one or more predefined subsets of the filing companies.

35. The non-transitory program storage device of claim 34, wherein the one or more predefined subsets of the filing companies are defined based on one or more of an industry group, number of employees, annual revenues, geographic region of business activities undertaken, types of the business activities undertaken, liabilities of members and directors, place of registration and control over management.

36. The non-transitory program storage device of claim 35, wherein the industry group is classified consistent with one or more of a Standard Industrial Classification (SIC) system, a North American Industry Classification System (NAICS), an International Standard Industrial Classification system, a Global Industry Classification Standard, a United Kingdom Standard Industrial Classification of Economic Activities, an Industry Classification Benchmark (ICB), a Russian Economic Activities Classification System (OKVED) and a Statistical classification of economic activities in the European Community (NACE).

37. The non-transitory program storage device of claim 29, wherein the financial document processing application comprises a hosted application and wherein said receiving comprises receiving live updates via web services.

38. The non-transitory program storage device of claim 29, wherein the financial document processing application comprises a desktop application and wherein said receiving comprises receiving configuration files containing therein the usage data.

39. The non-transitory program storage device of claim 29, wherein the regulatory agency is the Security Exchange Commission (SEC) and wherein the usage data comprises usage statistics for all SEC filing companies as a whole in relation to each XBRL reporting element of the current set of XBRL reporting elements.

40. The non-transitory program storage device of claim 29, wherein the end user comprises an external auditor of the company, a compliance officer of the company, a regulator employed by the regulatory agency or an investor.

41. The non-transitory program storage device of claim 29, wherein the providing visual feedback to the end user comprises highlighting differences in tagging between the tagged financial information and the one or more standardized documents previously filed with the regulatory agency by the one or more filing companies.

42. The non-transitory program storage device of claim 29, wherein the indication of prevalence comprises color-coding.

43. The method of claim 29, wherein the indication of prevalence comprises numerical data.

44. The non-transitory program storage device of claim 43, wherein the numerical data represents a percentage of the one or more filing companies that used each of the one or more taxonomy elements in connection with their standardized document filings with the regulatory agency.

45. A non-transitory program storage device readable by a computer system, tangibly embodying a program of instructions executable by one or more processors of the computer system to perform a method of communicating XBRL tag popularity, the method comprising:
presenting, by a financial document processing application configured to facilitate (i) tagging of financial information with extensible Business Reporting Language (XBRL) reporting elements and (ii) creation of XBRL documents in a form suitable for filing with the United States Securities and Exchange Commission (SEC), tagged financial information of an SEC filing company at issue to an end user for review or additional tagging;
receiving, by the financial document processing application, usage data for a plurality of SEC filing companies within a peer group of the SEC filing company at issue relating to their aggregate usage of one or more XBRL reporting elements in connection with one or more XBRL documents previously filed with the SEC by the plurality of SEC filing companies, wherein the one or more XBRL reporting elements are among a current set of XBRL reporting elements used within the tagged financial information and wherein the peer group is defined by an industry group with which the SEC filing company at issue is associated; and
providing visual feedback to the end user with respect to peer group norms by displaying, within a user interface of the financial document processing application, an indication of a percentage of the plurality of SEC filing companies that have used each of the one or more XBRL reporting elements in connection with their respective SEC filings.

46. The non-transitory program storage device of claim 45, wherein the industry group comprises a Standard Industrial Classification (SIC) code or a North American Industry Classification System (NAICS) code.

47. The non-transitory program storage device of claim 46, wherein the method further comprises maintaining, at a data center, a database of usage statistics, from which the usage data is extracted, that are generated based on analysis of historical XBRL document filings submitted to the SEC by SEC filing companies.

48. The non-transitory program storage device of claim 45, wherein the providing visual feedback to the end user comprises highlighting differences in tagging between the tagged financial information and the one or more XBRL documents previously filed with the SEC by the plurality of SEC filing companies.
